(19) United States
(12) Patent Application Publication
(10) Pub. No.: US 2017/0210487 A1
(43) Pub. Date: Jul. 27, 2017

(54) EMERGENCY RUNWAY

(71) Applicant: UMM AL-QURA UNIVERSITY, Makkah (SA)

(72) Inventor: Mohammed BASENDWAH, Blacksburg City, VA (US)

(73) Assignee: UMM AL-QURA UNIVERSITY, Makkah (SA)

(21) Appl. No.: 15/002,802

(22) Filed: Jan. 21, 2016

(51) Int. Cl. B64F 1/02; B66F 11/00; B64D 33/04

(52) U.S. Cl. CPC B64F 1/025; B64D 33/04; B66F 11/00

(57) ABSTRACT

An apparatus is provided to support aircraft with disabled landing gears. The apparatus comprises a support assembly, a hub, a shock absorber and a transport mechanism. The support assembly includes a contact component. The support assembly is rotatably connected to the hub. The shock absorber includes a first end to which the hub is rigidly connected. The transport mechanism is to move the apparatus along a ground surface. The contact component is to contact with and to support an aircraft fuselage during landing.

### BACKGROUND

Field of the Disclosure

The present disclosure is directed toward a method and apparatus to conduct emergency aircraft landings.

Description of the Related Art

The risk of aircraft fire, explosion, and catastrophic failure when landing with a mechanical or technical problem, and the attendant safety issues, have been addressed by a number of disclosures in the related art.

However, while aviation safety continues to improve, it continues to be a concern due to the potential severity of any serious failure, whatever the cause. Failures occur as the result of a wide variety of possibilities, but often arise from either accidents originating from pilot error, equipment malfunction due to manufacturing or maintenance failures, or outside interference such as unexpected weather or operating conditions, or terrorist attacks.

Equipment malfunction can occur in a variety of ways including, for example, failures and leaks from hydraulic equipment that operates landing gears, interference inside the landing gear wheel well, such as from debris or the presence of stowaways. For these reasons, methods and apparatus for safely landing aircraft with disabled landing gear mechanisms continue to be developed with the aim of reducing the extent of the damage when such incidents occur.

### SUMMARY

In one example aspect, an apparatus is provided to support aircraft with disabled landing gears. The apparatus comprises a support assembly, a hub, a shock absorber and a transport mechanism. The support assembly includes a contact component. The support assembly is rotatably connected to the hub. The shock absorber includes a first end to which the hub is rigidly connected. The transport mechanism is to move the apparatus along a ground surface. The contact component is to contact with and to support an aircraft fuselage during landing.

In another example aspect, a system is provided to support aircraft landing with malfunctioning landing gears. The system comprises a plurality of landing struts and a control system. Each landing strut includes a support assembly and a tilt platform. The tilt platform is to adjust an angular position of the support assembly. The control system is to adjust a position of the landing strut. The plurality of rows of the landing struts is configured along a ground surface to form an emergency runway. Each support assembly is disposed with an axis of rotation perpendicular to a forward path of an aircraft in a plan view. Each row of the landing struts includes three landing struts adjusted laterally by the control system with respect to the emergency runway and the support assembly of the landing struts is angularly adjusted by the tilt platform to follow a cross section of an aircraft fuselage, for the fuselage of an aircraft to land and stop.

In yet another example aspect, a method is provided to land an aircraft with malfunctioning landing gears. The method uses a plurality of landing struts. Each landing strut includes a support assembly and a brake. A position of the support assembly is adjustable. The method comprises identifying information relating to an aircraft including a type and dimensions, adjusting a position of the support assembly of the plurality of landing struts on an emergency runway based on the information so as to accommodate a landing of the aircraft, and applying the brake system of each support assembly as the aircraft traverses each of the landing struts.

The foregoing general description of the illustrative implementations and the following detailed description thereof are merely exemplary aspects of the teachings of this disclosure, and are not restrictive.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein:

FIG. 1A and 1B are front and side views, respectively, of an example embodiment of a landing strut mechanism;

FIG. 2A and 2B are side and plan views, respectively, of an example embodiment of a landing strut platform;

FIG. 3 is a front view of an example embodiment of a landing strut;

FIG. 4 is a front view of an example array of the landing struts supporting an aircraft;

FIG. 5 is a plan view of a section of an example embodiment of an emergency runway;

FIG. 6A and 6B are side views of sections of different embodiments of the emergency runway;

FIG. 7 is a diagram of an embodiment of a process for controlling the operation of a plurality of landing struts.

### DETAILED DESCRIPTION OF THE EMBODIMENTS

In the drawings, like reference numerals designate identical or corresponding parts throughout the several views. Further, as used herein, the words “a”, “an” and the like generally carry a meaning of “one or more”, unless stated otherwise. The drawings are generally not drawn to scale unless specified otherwise or illustrating schematic structures or flowcharts.

Referring now to the drawings, wherein like reference numerals designate identical or corresponding parts throughout the several views.

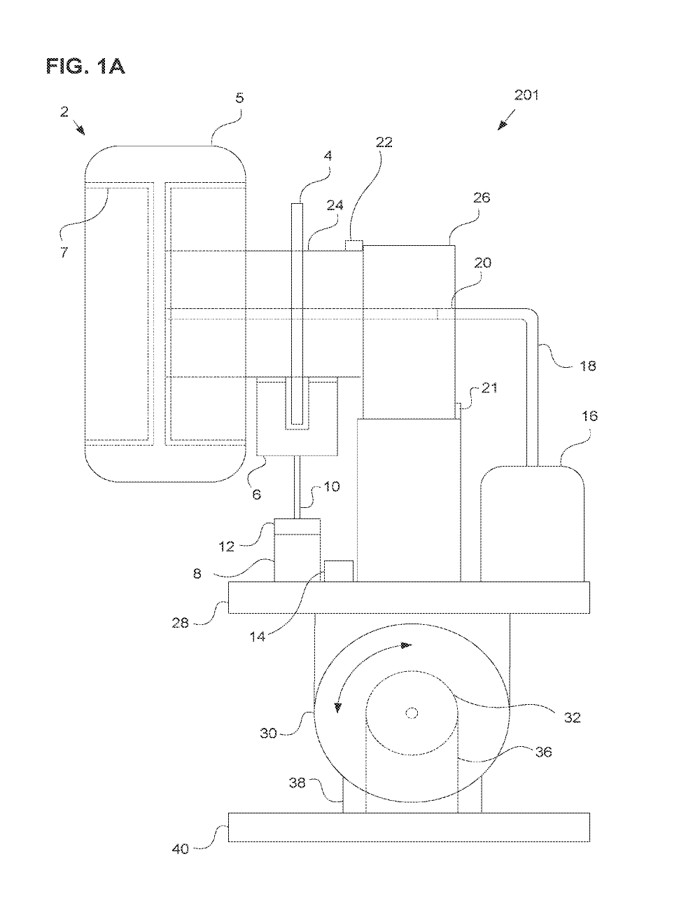

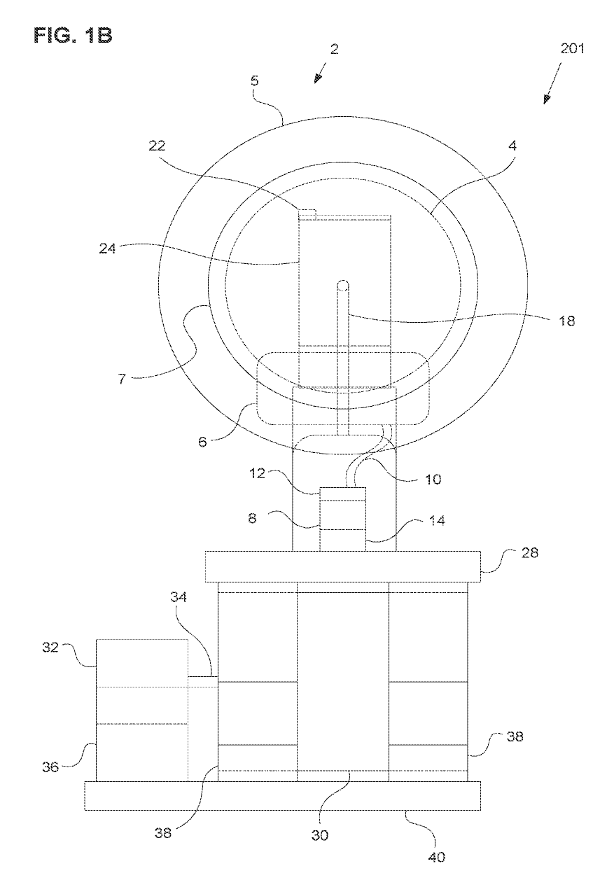

FIG. 1A and FIG. 1B are front and side views, respectively, of a landing strut 201 including a support assembly 2, and a plurality of contact components 5, where the contact components 5 may make contact with and support a fuselage of an aircraft 100 during landing. The contact components 5 may make contact with and absorb the impact of the aircraft 100 as the aircraft 100 lands. The contact components 5 may include apparatus such as pneumatic pressurized tires and wheels, inflatable bladders, and various types of continuous track assemblies such as those found on tanks and earthmoving machinery.

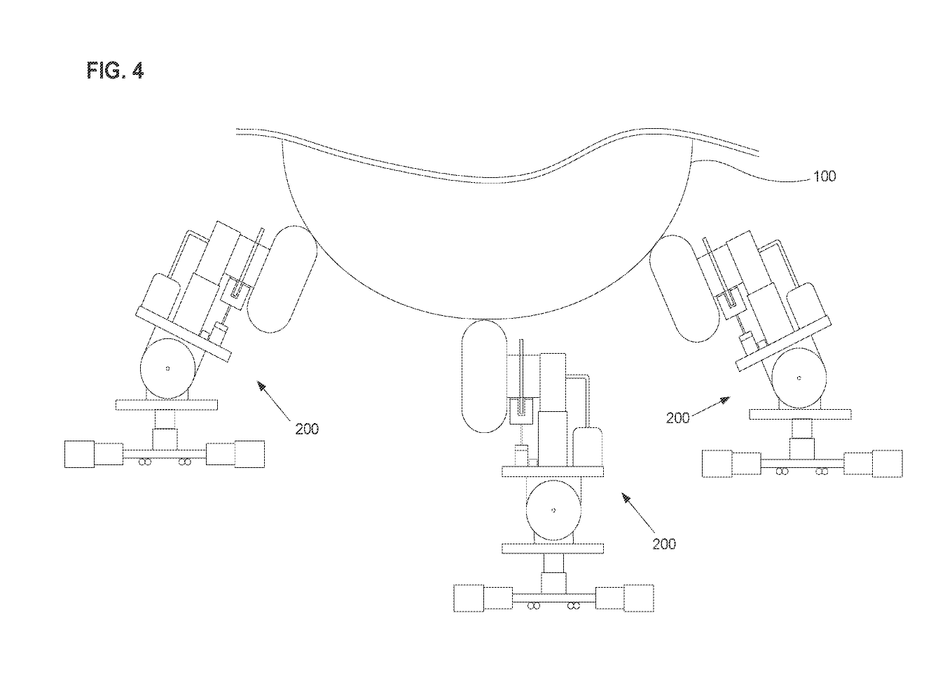

In one embodiment, the support assembly 2 has a contact component 5 that may be a pressurized pneumatic tire that is connected to a wheel 7, and a hub 24 to which the support assembly 2 is rotatably connected. A shock absorber 26 includes a first end to which the hub 24 is rigidly connected. The shock absorber 26 also includes a second end which is connected to or supported by a tilt platform 28. The support assembly 2 is connected to a compressed air tank 16 by a pneumatic line 18 and a brake system 3. The brake system 3 includes a brake rotor 4, a brake caliper 6, a brake cylinder 8, and a hydraulic brake line 10. The brake rotor 4 is connected to the hub 24 and the brake caliper 6 is also connected to the hub 24. The brake caliper 6 is further connected to the brake cylinder 8 which is supported by the tilt platform 28 and an Anti-lock Brake System (ABS) controller 12 by the hydraulic brake line 10. The operation of the landing strut 201 is controlled by a controller 14 that is connected to the tilt platform 28 and, wired or wirelessly, to an air pressure controller 20, including an air pressure sensor 20a and an air pressure relief valve 20b, a position sensor 21, a wheel speed sensor 22, the brake cylinder 8, the ABS controller 12, and the compressed air tank 16. The support assembly 2 is a contact component hollow wheel and tire combination with internal passages for supplying the chamber with air. The support assembly 2 is connected to and rotates freely relative to the hub 24, which is rigidly connected to the shock absorber 26. The shock absorber 26 supports the force transmitted by an aircraft 100 (FIG. 4) upon landing, and absorbs the impact from the support assembly 2 and the hub 24. The compressed air tank 16 supplies air pressure to the support assembly 2 via the pneumatic line 18 to vary pressure within the support assembly 2 to account for load differences from various types and conditions of aircraft 100, while the air pressure controller relieves air pressure in the support assembly 2 and automatically adjusts pressure as needed. The compressed air tank 16 is supplied by one or more separate compressed air sources (not shown), for example a compressor or air pressure reservoir. The brake caliper 6 provides braking force on the brake rotor 4 which rotates with the hub 24. The wheel speed sensor 22 detects rotational speed of the support assembly 2. The controller 14 uses that data to adjust the ABS controller 12 as needed.

In one embodiment, the controller 14 adjusts damping characteristics of the shock absorber 26 based on signals received from the position sensor 21. The tilt platform 28 is supported by a tilt drum 30, which is connected to at least one drum support 38. The tilt drum 30 is connected to the drum support 38 and an elevator platform 40 which is disposed on a ground surface and underneath the drum support 38. A servo motor 32 is connected to a motor support 36 which is supported by the elevator platform 40. The tilt drum 30 rotates about its center and is connected to the servo motor 32 by a coupling 34. The angular position of the landing strut 201 is determined by the position of the tilt platform 28 on the tilt drum 30. The tilt drum 30 rotates due to rotation of the servo motor 32 and the coupling 34 (FIG. 1B).

In a one embodiment, the ABS controller 12 is connected between the brake cylinder 8 and a hydraulic brake line 10 to provide ABS functionality for the landing strut 201. The controller 14 controls the functions of the landing strut 201, receives signals from various on-board sensors as well as from external networks and sources.

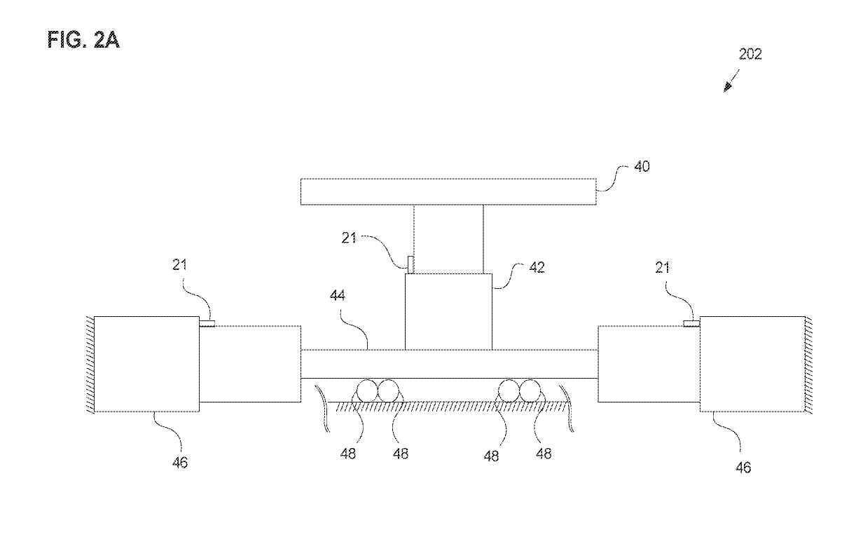

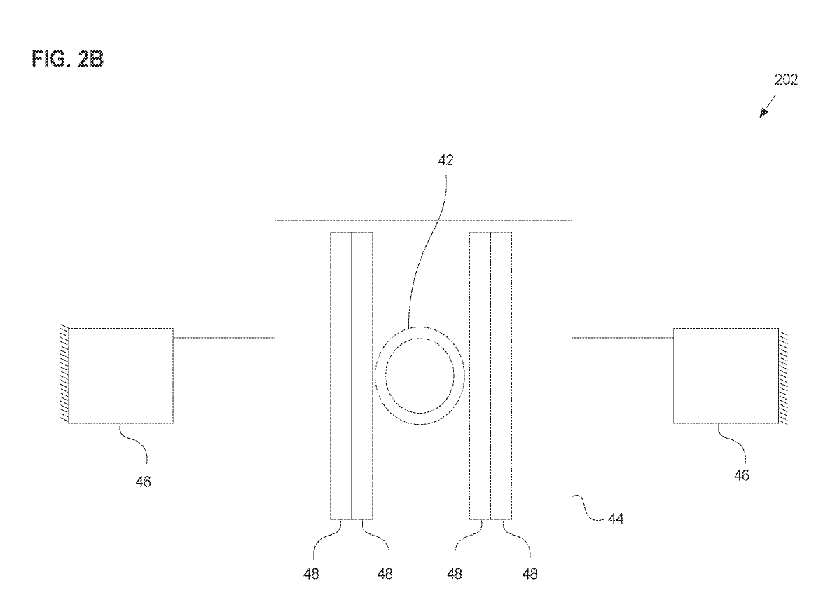

FIG. 2A and FIG. 2B are side and plan views, respectively, describing a transport mechanism 210 to move the landing strut along a ground surface. In one embodiment, the transport mechanism 210 is a landing strut platform 202 having an elevator platform 40 (same as shown in FIG. 1A and FIG. 1B), connected to a first hydraulic piston 42, a lateral platform 44, four rollers 48, and a second and a third hydraulic piston 46. In one embodiment the first hydraulic piston 42 may be positioned vertically, and the second and the third hydraulic pistons 46 may be positioned laterally. The elevator platform 40 is supported at its center from beneath by the first hydraulic piston 42, which is supported underneath by the lateral platform 44, which rests on the rollers 48. The axes of the rollers 48 may be parallel to that of the tilt drum 30. The lateral platform 44 includes a first end and a second, opposite end which are connected to the second and the third hydraulic pistons 46 respectively. The first hydraulic piston 42 moves vertically and adjusts the height of the elevator platform 40 above it. The lateral platform 44 supporting the first hydraulic piston 42 moves laterally based on the rollers 48 beneath it. The lateral movement of the lateral platform 44 is controlled by the inputs of the second and the third hydraulic pistons 46, each secured to a rigid surface at one end while the other end is connected to the lateral platform 44 and able to extend and retract in horizontal directions that are perpendicular to the axes of the two rollers 48. The operation of the first hydraulic piston 42 and second and the third hydraulic pistons 46, each of which is connected to a position sensor 21, are also monitored and controlled by the controller 14 (FIG. 1A and FIG. 1B).

In another embodiment, the lateral platform 44 has two rollers 48 rather than the four rollers 48 shown in the figure.

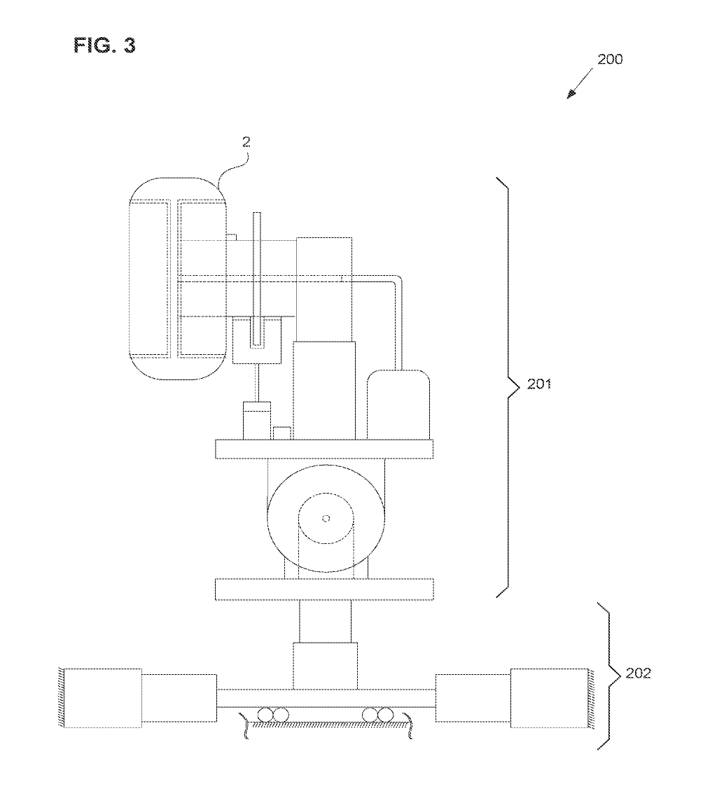

FIG. 3 is a front view of the landing strut 200, the assembly comprising the landing strut 201 and the landing strut platform 202 (described by FIG. 1A and FIG. 2A, respectively) to position the apparatus in the lateral, vertical, and angular directions, and to support a load applied to the support assembly 2.

FIG. 4 is a front view of an array of three landing struts 200 supporting an aircraft 100, one landing strut 200 at the center 200, one landing strut 200 toward the right side of the aircraft 100, and one landing strut 200 toward the left side of the aircraft 100. The contact component 5 of the support assembly 2 supports a load acting a substantially radial direction with respect to axis of rotation of the support assembly 2. The landing strut platform 202 (FIG. 2) allows for lateral adjustment of the position of each landing strut 200 by the controller 14 to accommodate various commercial aircraft fuselage 101 shapes and widths approximately in the range of 15 to 25 feet. The support assembly 2 is also angularly adjusted by the rotation of the tilt platform 28 based on the operation of the tilt drum 30 to follow a cross-section of the aircraft fuselage.

In addition to the vertical adjustment of the position of the support assembly 2 through the use of the first hydraulic piston 42 (FIG. 2A and FIG. 2B), the height of each landing strut 200 can also be set during initial installation within a plurality of ground surfaces, for example, the middle column of landing struts 200 can be positioned on a lower ground surface than that of the side positions since the vertical position of the landing strut 200 located on the side positions is higher to make contact with a round aircraft fuselage 101 and tilts to one side, reducing the effective height of the landing strut 200 upon which the support assembly 2 is mounted.

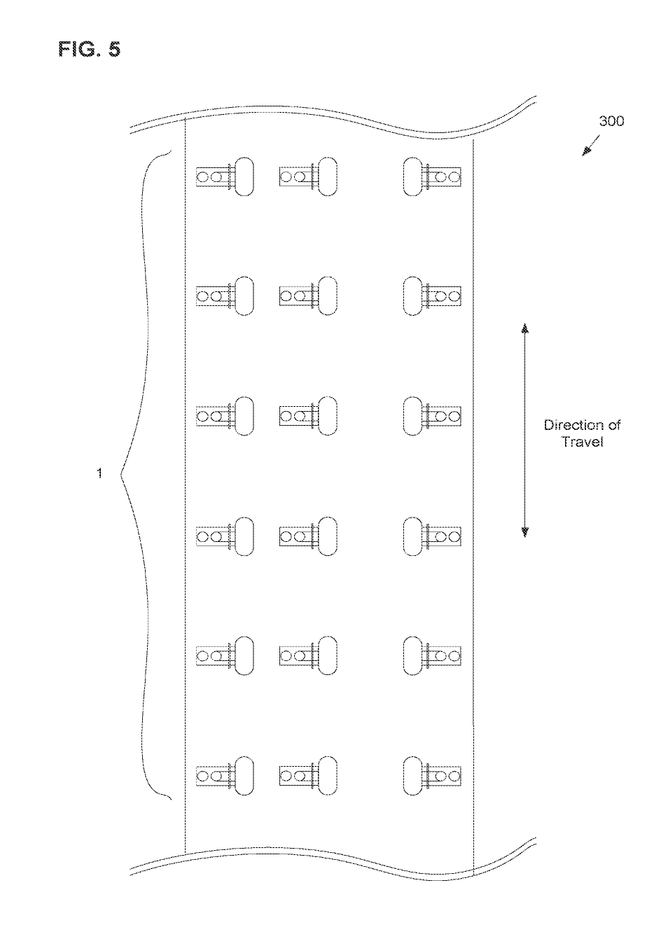

FIG. 5 is a plan view of a section of an emergency runway 300 having a plurality of landing struts 200 configured in three columns along multiple rows in a length-wise pattern, and includes a center column of upright suspended landing struts 200, and outside columns tilted inwardly toward the center row of upright suspended wheel assemblies 2. Since each landing strut 200 freewheels and mechanically operates independently of any drive force, it is free to rotate in either direction, allowing the mounting of each landing strut 200 and use of the emergency runway 300 in either direction, providing greater flexibility of use with prevailing weather conditions. Total length of the emergency runway 300 is in the range of between one and three miles, with longitudinal spacing between the landing struts 200 approximately in the range of between five and ten feet, for a total of about 1,500 to 9,500 landing struts 200 per emergency runway 300.

In another embodiment, each landing strut 200 has two landing strut platforms 202 (FIG. 2B) one positioned above the other in a side view, and positioned orthogonal to one another in a plan view, allowing for movement of the landing strut 200 in both the lateral and longitudinal directions, therefore allowing longitudinal spacing between the landing struts 200 to be adjusted. The embodiment shown in FIG. 2A and FIG. 2B has one landing strut platform 202 and can only move along one axis.

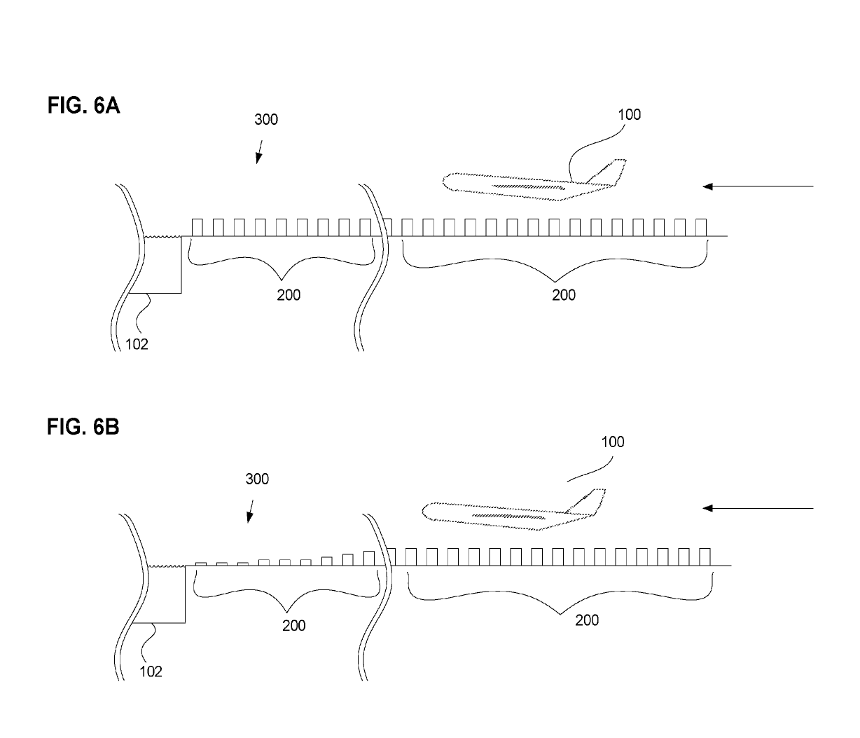

FIG. 6A and FIG. 6B are side views of sections of embodiments of an emergency runway 300, the emergency runway 300 shown as rows of landing strut 200 with a landing pit 102 and an aircraft 100. An aircraft 100 without properly functioning landing gears is redirected from landing on a runway to an emergency runway 300, to attempt a safe landing. All landing gears may be retracted prior to landing on the emergency runway 300. Landing on the emergency runway 300 may be possible even if the landing gears are not retracted depending on the location of the landing gears with respect to the aircraft 100. For example, landing on the emergency runway may be possible if no landing gears are located below the aircraft fuselage 101. As with a regular landing, the tail section of the aircraft 100 touches down on the emergency runway 300 first. On each landing strut 200, the support assembly 2 that makes contact with the aircraft fuselage 101 begins to rotate. Each landing strut 200 in contact with the aircraft 100 begins to slow the aircraft 100 through a small amount of rolling resistance and friction inherent in the support assembly 2 and hub 24. Further, a modest amount of braking power is provided by the brake caliper 6 applying a force to the brake rotor 4 of each landing strut 200. Once the aircraft 100 is level and fully supported by the array of landing struts 200, greater braking power can be supplied by each of the brake calipers 6 on the landing struts 200 in contact with the aircraft 100. Further, a thrust reverser 104 of an aircraft engine 103 can be engaged to further reduce speed of the aircraft 100.

While the position of each landing strut 200 remains the same relative to the other two landing struts 200 in a row across the emergency runway 300, the height of each row can vary with that of other rows along the length of the emergency runway 300, for example to create an upward or downward slope over the length of the emergency runway 300. The variation in height between rows of landing struts 200 is adjusted by the first hydraulic piston 42 of each landing strut 200 (FIG. 2A). An emergency runway 300 with an upward sloping array of landing struts 200 slows the aircraft 100 at a faster rate. An emergency runway 300 with a downward sloping array of landing struts 200 provides a smoother transition for the aircraft 100 to enter the landing pit 102.

In one embodiment, a landing pit 102 is located at one or both ends of the emergency runway 300 such that the aircraft 100 is slowed by the array of landing struts 200 along the length of the emergency runway 300, and then comes to a stop before or in the landing pit 102 located at the end of the array of landing struts 200. The landing pit 102 may be filled with a material or mixture of material, for example, sand, dirt, soft soil or liquid, to retard the forward motion of the aircraft 100, reduce the risk of fire, and maintain an upright position of the aircraft 100 to ease rescue operations, while minimizing the risk of injury to passengers and ground crew, and of damage to the aircraft 100.

In one embodiment, the emergency runway 300 has a landing pit 102 at each end, the landing pit 102 is a manmade body of water such as a large pool or canal which may connect to a larger body of water such as a river or lake, providing additional runoff room for the aircraft 100.

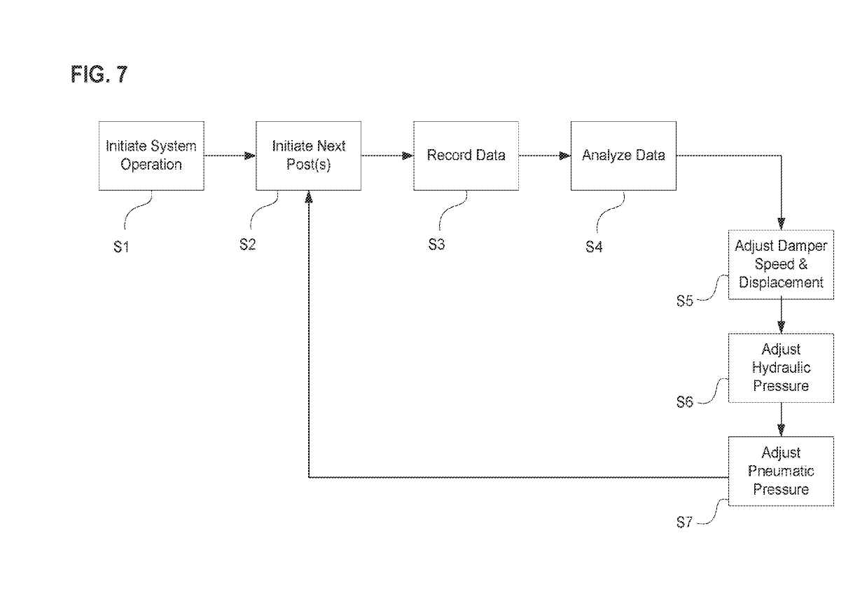

FIG. 7 is a diagram of an embodiment of a process of the controller 14 for controlling the operation of a plurality of landing struts 200 of an emergency runway 300. Operation of the controller 14 is initiated at Step S1 when use of the emergency runway 300 is needed.

At Step S1, an aircraft 100 that is expected to arrive at the emergency runway 300 is identified and initial data is input, including sources external to the landing strut 200 such as data about the expected aircraft 100. Example data may include aircraft type, fuselage dimensions, weight, approach speed (generally at a rate of around aircraft 100 to 130 knots), approach angle, wind speed, and ambient weather conditions. The angular, vertical and lateral position of the support assembly 2 of each landing strut 200 is adjusted as needed to accommodate the dimensions of the incoming aircraft fuselage 101.

At Step S2, the controller 14 transmits its available data elements to the controller 14 of at least the next landing strut 200 along the anticipated path of travel of the aircraft 100 on the emergency runway 300. Available data include those provided by all the sensors described by FIG. 1A and FIG. 1B, such as wheel speed, brake pressure, and position and velocity readings of the various hydraulic dampers and pistons.

At Step S3, data received from Step S2 are recorded to memory.

At Step S4, system-level analysis of the emergency runway 300 is performed on the data from Step S3. Example data of interest include how many and which landing struts 200 have made contact with the aircraft 100. This can determine if the aircraft 100 has made full contact with the emergency runway 300, the velocity of the aircraft 100 along the emergency runway 300, and if the rate of deceleration of the aircraft 100 is sufficient such that the aircraft 100 will come to a stop before the aircraft 100 reaches the end of the emergency runway 300.

Based on the analysis of Step S4, local analysis of the particular landing strut 200 is performed to determine which settings of Steps S5 through Step S7 should be adjusted.

At Step S5, if applicable, damping stiffness of the shock absorber 26 is adjusted in case the load is out of tolerance relative to the downward load applied.

At Step S6, hydraulic brake pressure applied is adjusted by the ABS controller 12 based on rotation speed of the support assembly 2 to prevent the support assembly 2 from locking. However, the hydraulic pressure applied can be varied from one end of the emergency runway 300 toward the other to provide optimal brake force once the aircraft 100 has stabilized on the emergency runway 300. For example, the brake force applied by each subsequent landing strut 200 is gradually increased to maintain a state of threshold braking and maximize effectiveness for each support assembly 2.

At Step S7, pneumatic air pressure is adjusted in the support assembly 2 if pressure readings are out of tolerance for the given pressure and load upon the support assembly 2, primarily a function of the weight of the aircraft 100.

The aforementioned adjustments may occur as the aircraft 100 is traversing each landing strut 200.

Upon completion of Step S7, the process of FIG. 7 returns to Step S2 and repeats the loop until the aircraft 100 has come to a stop or passed the final landing strut 200 of the emergency runway 300.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernable variants of the teachings herein, defines, in part, the scope of the foregoing claim terminology such that no inventive subject matter is dedicated to the public.

What is claimed is:

1. An apparatus to support an aircraft with disabled landing gears, the apparatus comprising:
a support assembly including a contact component;
a hub to which the support assembly is rotatably connected;
a shock absorber including a first end to which the hub is rigidly connected; and
a transport mechanism to move the apparatus along a ground surface,
wherein the contact component is to contact with and support an aircraft fuselage during landing.

2. The apparatus of claim 1, wherein the contact component is a pressurized pneumatic tire, and the contact component is to support a load acting in a substantially radial direction with respect to the support assembly.

3. The apparatus of claim 1, further comprising:
a tilt platform,
wherein a second end of the shock absorber is connected to the tilt platform.

4. The apparatus of claim 3, further comprising:
a brake caliper;
a brake rotor;
a brake cylinder; and
a hydraulic brake line,
wherein the at least one brake caliper and the brake rotor are connected to the hub, the brake cylinder is connected to the tilt platform, and the hydraulic brake line connecting the brake cylinder and the at least one brake caliper.

5. The apparatus of claim 4, further comprising an anti-lock brake system controller.

6. The apparatus of claim 3, further comprising:
a tilt drum;
a drum support;
a servo motor; and
a coupling,
wherein the tilt platform is supported by the tilt drum and the drum support on a ground surface, the servo motor is connected to the tilt drum by the coupling, and the servo motor is to rotate the tilt drum over a range of motion to adjust an angular position of the tilt platform.

7. The apparatus of claim 6, further comprising:
an elevator platform;
a first hydraulic piston; and
a lateral platform,
wherein the lateral platform supports the first hydraulic piston that supports the elevator platform, the elevator platform is disposed underneath and connected to the drum support, and operation of the first hydraulic piston changes an elevation of the support assembly.

8. The apparatus of claim 7, further comprising:
at least two rollers, with axes parallel to that of the tilt drum and disposed underneath the lateral platform,
a second hydraulic piston; and
a third hydraulic piston,
wherein the lateral platform is supported by the at least two rollers, the second hydraulic piston is connected to a first end of the lateral platform, the third hydraulic piston is connected to a second, opposite end of the lateral platform, the second and third hydraulic pistons each with one end fixed to ground such that the position of the lateral platform can be adjusted along the horizontal plane in a direction perpendicular to the axes of the at least two rollers.

9. The apparatus of claim 2, further comprising:
a compressed air tank;
a pneumatic line; and
an air pressure controller;
wherein a tire pressure of the support assembly is automatically adjustable by the compressed air tank.

10. A system to support an aircraft, landing with malfunctioning landing gears, comprising:
a plurality of landing struts, each including a support assembly and a tilt platform, the tilt platform to adjust an angular position of the support assembly; and
a controller to adjust a position of the landing strut,
wherein a plurality of rows of the landing struts are configured along a ground surface to form an emergency runway, each support assembly is disposed with an axis of rotation perpendicular to a forward path of the aircraft in a plan view, each row of the landing struts includes three landing struts adjusted laterally by the control system with respect to the emergency runway, and the support assembly of the landing struts being angularly adjusted by the tilt platform to follow a cross section of an aircraft fuselage, for the aircraft to land and stop.

11. The system of claim 10, further comprising:
a landing pit,
wherein the landing pit is filled with a soft material and positioned at an end of the plurality of the landing struts.

12. The system of claim 11, wherein:
the landing pit is filled with sand.

13. The system of claim 12, wherein:
the landing pit is filled with liquid.

14. A method for landing aircraft with malfunctioning landing gears using a plurality of landing struts, each of the landing struts including a support assembly and a brake system, a position of the support assembly being adjustable, the method comprising:
identifying information relating to an aircraft including a type and dimensions;
adjusting a position of the support assembly of a plurality of landing struts on an emergency runway based on the information so as to accommodate a landing of the aircraft; and
applying the brake system of each support assembly as the aircraft traverses each of the landing struts.

15. The method of claim 14, further comprising:
applying a thrust reverser once the aircraft is fully supported by the plurality of landing struts.

16. The method of claim 14, the support assembly further including a shock absorber, the method further comprising:
adjusting a stiffness of the shock absorber of each support assembly.

17. The method of claim 14, the support assembly further including a pressurized pneumatic tire, the method further comprising:
adjusting a pressure of the pressurized pneumatic tire of each support assembly.

18. The method of claim 14, wherein:
the position of the support assembly is adjustable angularly, vertically and laterally.

19. The method of claim 14, further comprising:
adjusting a vertical position of the landing struts to form a slope in an emergency runway along the forward path of the aircraft.
